(19) United States
(12) Patent Application Publication
(10) Pub. No.: US 2005/0073238 A1
(43) Pub. Date: Apr. 7, 2005

(54) Cathode ray tube

(76) Inventors: Yoshihito Matsuura, Tokyo (JP); Kiyoshi Aoki, Tokyo (JP); Mizuki Murata, Tokyo (JP); Kazushi Nagasawa, Tokyo (JP); Hisanobu Tokunaga, Tokyo (JP)

Correspondence Address: BIRCH STEWART KOLASCH & BIRCH, PO BOX 747, FALLS CHURCH, VA, 22040-0747, US

(21) Appl. No.: 10/648,362

(22) Filed: Aug. 27, 2003

(30) Foreign Application Priority Data
Feb. 25, 2003 (JP) 2003-047061

(51) Int. Cl. H01J 31/00

(52) U.S. Cl. 313/477 R

(57) ABSTRACT

A cathode ray tube has a vacuum enclosure including a panel (1) having a screen (1a), a funnel (2) connected to the panel (1), and a neck (3) connected to the narrow part of the funnel (2). The funnel (2) has a yoke-mounting portion (5) on which a deflection yoke (7) is mounted. The sectional shape of the yoke-mounting portion (5), cut by a plane perpendicular to the tube axis of the funnel (2), varies from a circular shape to a substantially barrel shape having a maximum dimension at least in a direction of the horizontal axis or the vertical axis, as the position shifts from the neck (3) side to the panel (1) side of the yoke-mounting portion (5). With such an arrangement, the resistance to the external pressure can be improved, and the deflection power consumption can be reduced.

### BACKGROUND OF THE INVENTION

This invention relates to a cathode ray tube employed in a television, a display device of a computer or the like.

A cathode ray tube employed in a television, a display device of a computer or the like has an electron gun that emits an electron beam and a deflection yoke that deflects the electron beam emitted by the electron gun. The deflection yoke deflects the electron beam in directions of a horizontal axis and a vertical axis on a screen, so that the screen is scanned. The deflection yoke is mounted on the outer surface of a narrow part of a funnel, and the electron gun is mounted in a cylindrical neck connected to the narrow part of the funnel. Recently, the cathode ray tube has a relatively high deflection frequency, and therefore a deflection power consumption (i.e., an electrical power consumed by the deflection yoke) increases. In order to reduce the deflection power consumption, the deflection yoke needs to be located proximately to a region through which the electron beam passes (hereinafter, referred to as a beam passage region) so that the deflection magnetic field efficiently acts on the electron beam. For this purpose, a recently proposed cathode ray tube has a structure in which the sectional shape of the narrow part of the funnel gradually varies from a circular shape to a rectangular shape, as the position shifts from the neck side to the panel side of the funnel. Such a cathode ray tube is disclosed in Japanese Laid-Open Patent Publication Nos. HEI 10-144238, 2000-113840, and 2000-323070.

However, as the funnel of the above-described cathode ray tube has the rectangular-shaped portion, side walls of the rectangular-shaped portion may deform inwardly when the cathode ray tube is evacuated. Thus, a crack may be formed at the corner of the rectangular-shaped portion, with the result that the resistance to external pressure (i.e., atmospheric pressure) decreases. In order to prevent the generation of the crack, the narrow part of the funnel needs to be rounded as a whole. However, if the narrow part of the funnel is rounded, the deflection yoke can not be located proximately to the beam passage region in the funnel, so that the deflection power consumption can not be reduced.

The reduction of the deflection power consumption can be accomplished by reducing the cross sectional area of the narrow part of the funnel. However, if the cross sectional area of the narrow part of the funnel is reduced, a so-called BSN (Beam Strike Neck) phenomenon may occur. The BSN phenomenon is a phenomenon where the electron beam directed to the corner of the screen collides with the inner surface of the narrow part, so that the quality of the image is degraded.

Furthermore, a general cathode ray tube has an inner conductive film formed on the inner surface of the funnel for keeping constant the electrical potential of the interior of the cathode ray tube. The inner conductive film is formed by applying a graphite slurry to the inner surface of the funnel while the funnel is rotated in such a manner that the graphite slurry flows from the panel side toward the neck side of the funnel. This method is called a flow-coat. If the narrow part of the funnel has the rectangular-shaped portion as described above, a part of the slurry accumulates at the corner of the rectangular-shaped portion, so that the coating may become uneven. In such a case, after the slurry is dried (i.e., after the inner conductive film is formed), a part of the inner conductive film may flake off and may adhere to a color selection electrode.

Additionally, the general cathode ray tube has a getter for ensuring a vacuum in the cathode ray tube. The getter is mounted on a tip of a strip-shaped getter supporting member disposed along the inner surface of the funnel. Thus, if the narrow part of the funnel has a rectangular-shaped portion, there is little space outside the beam passage region in the narrow part of the funnel. As a result, the getter supporting member must be located in the proximity of the beam passage region, and therefore a shadow of the getter supporting member may appear on the screen, or the convergence on the lower part of the screen may decrease.

### SUMMARY OF THE INVENTION

An object of the present invention is to provide a cathode ray tube capable of improving the resistance to external pressure, reducing a deflection power consumption, improving the quality of an image, and simplifying the installation of a getter and the formation of an inner conductive film.

According to the invention, there is provided a cathode ray tube including a vacuum enclosure. The vacuum enclosure includes a panel, a substantially funnel-shaped portion and a substantially cylindrical neck. The panel has a substantially rectangular screen on which a horizontal direction and a vertical direction are defined. A tube axis is defined in the funnel-shaped portion. One end of the funnel-shaped portion in a direction of the tube axis is connected to the panel. The neck is connected to an opposite end of the funnel-shaped portion. An electron gun is provided in the neck. The funnel-shaped portion includes a yoke-mounting portion adjacent to the neck. The yoke-mounting portion has an outer surface for mounting a deflection yoke that deflects an electron beam emitted by the electron gun in directions of the horizontal axis and the vertical axis. A sectional shape of the outer surface of the yoke-mounting portion, cut by a plane perpendicular to the tube axis, varies from a substantially circular shape to a substantially barrel shape having a maximum dimension at least in a direction of the horizontal axis or the vertical axis, as the position shifts from the neck side to the panel side of the yoke-mounting portion.

With such an arrangement, the resistance to external pressure can be improved, and the deflection power consumption can be reduced. Further, the degradation of the image can be prevented. Additionally, the inner conductive film can be easily formed in the funnel-shaped portion, and the sufficient space can be provided in the funnel-shaped portion for mounting the getter supporting member.

### BRIEF DESCRIPTION OF THE DRAWINGS

In the attached drawings:

FIG. 1 is a perspective view illustrating an outer shape of a cathode ray tube according to Embodiment 1 of the present invention;

FIG. 2 is a sectional view illustrating an internal structure of the cathode ray tube according to Embodiment 1;

FIGS. 3A and 3B are sectional views illustrating the variation, along the tube axis, of the sectional shape of a yoke-mounting portion of the cathode ray tube according to Embodiment 1;

FIG. 4 is a sectional view illustrating one fourth of the sectional shape of the yoke-mounting portion of the cathode ray tube according to Embodiment 1;

FIG. 5 is a sectional view illustrating a comparative example as opposed to the cathode ray tube according to Embodiment 1;

FIG. 6 is a perspective view illustrating an outer shape of a cathode ray tube according to Embodiment 2 of the present invention;

FIGS. 7A and 7B are sectional views illustrating the variation, along the tube axis, of the sectional shape of a yoke-mounting portion of the cathode ray tube according to Embodiment 2; and

FIG. 8 is a sectional view illustrating one fourth of the sectional shape of the yoke-mounting portion of the cathode ray tube according to Embodiment 2.

### DETAILED DESCRIPTION OF THE INVENTION

Embodiments of the present invention will be described with reference to the attached drawings.

Embodiment 1.

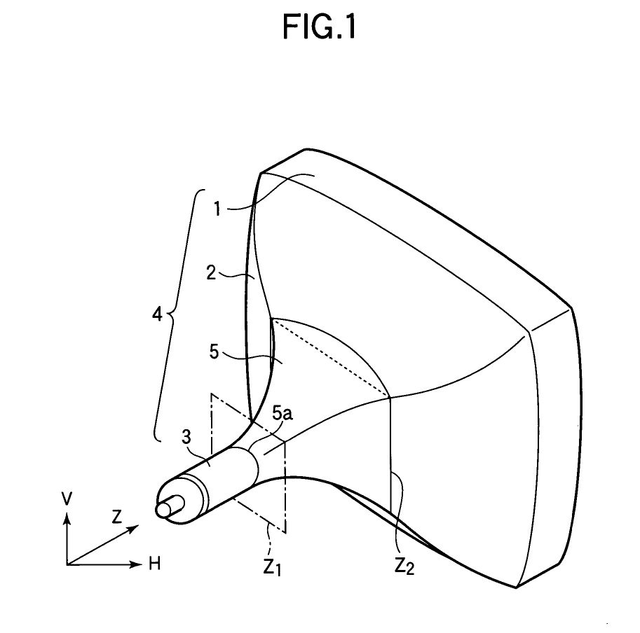

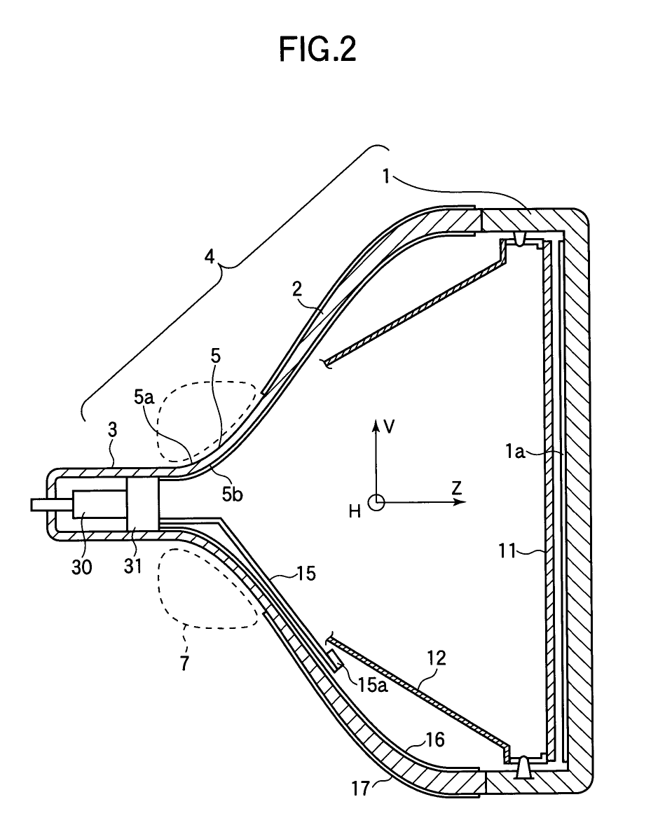

FIGS. 1 and 2 are a perspective view and a sectional view of a cathode ray tube according to Embodiment 1. As shown in FIG. 1, the cathode ray tube according to Embodiment 1 includes a vacuum enclosure 4. The vacuum enclosure 4 includes a rectangular panel 1, a funnel (i.e., a substantially funnel-shaped portion) 2 connected to the panel 1, and a cylindrical neck 3 connected to a narrow part of the funnel 2. The funnel 2 has a structure in which a so-called tube axis (Z-axis) is defined. As shown in FIG. 2, a screen 1a is formed on the inner surface of the panel 1. The screen 1a has phosphors emitting blue, green and red light. The screen 1a has a rectangular shape. The horizontal (H) axis is defined as an axis in parallel with long sides of the screen 1a. The vertical (V) axis is defined as an axis in parallel with short sides of the screen 1a. The ratio (i.e., an aspect ratio) of the dimension M of the screen 1a along H-axis to the dimension N of the screen 1a along V-axis (M:N) is 4:3 or 16:9.

A shadow mask 11 (i.e., a color selection electrode) is disposed inside the panel 1 in such a manner that the shadow mask 11 faces the screen 1a of the panel 1. An inner magnetic shield 12 is fixed to the shadow mask 11. An electron gun unit 31 is provided in the neck 3. The electron gun unit 31 includes an electron gun 30 of a so-called in-line type having three beam emitting portions arranged in the direction of H-axis.

A deflection yoke 7 is mounted on the funnel 2. The deflection yoke 7 generates a horizontal deflection magnetic field and a vertical deflection magnetic field for deflecting the electron beam in the directions of H-axis and V-axis, so that the screen 1a is scanned in the directions of H-axis and V-axis. The deflection yoke 7 is fixed to the outer surface of a yoke-mounting portion 5 of the funnel 2. The yoke-mounting portion 5 is constructed of the narrow part of the funnel 2 adjacent to the neck 3.

As shown in FIG. 1, the position of a rear end (i.e., the end on the neck 3 side) of the yoke-mounting portion 5 is referred to as a rear end position Z1, and the position of a front end (i.e., the end on the panel 1 side) of the yoke-mounting portion 5 is referred to as a front end position Z2. The sectional shape of the yoke-mounting portion 5, cut by a plane perpendicular to Z-axis, gradually varies as the position shifts from the rear end position Z1 to the front end position Z2 along Z-axis.

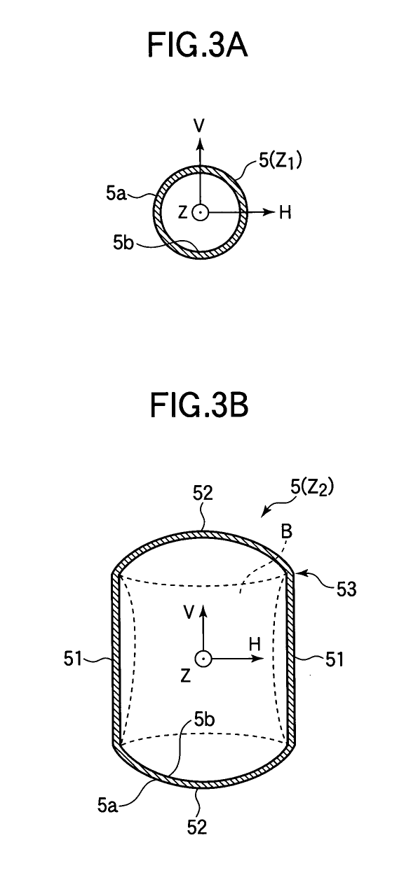

FIGS. 3A and 3B are schematic views illustrating the sectional views of the yoke-mounting portion 5 at the rear end position Z1 and the front end position Z2. The sectional shape of the yoke-mounting portion 5, cut by the plane perpendicular to Z-axis, gradually varies from a circular shape (FIG. 3A) to a substantially barrel shape (FIG. 3B), as the position shifts from the rear end position Z1 to the front end position Z2.

In FIG. 3B, the yoke-mounting portion 5 includes two straight side walls 51 and two arc-shaped side walls 52. The straight side walls 51 straightly extend along V-axis. The arc-shaped side walls 52 extend in the form of circular arcs having a radius Rd and having the center of curvature aligned on Z-axis. Corners 53 between the straight side walls 51 and the arc-shaped side walls 52 are obtuse-angled. The arc-shaped side walls 52 are symmetrical about H-axis, and bend outward in the direction away from Z-axis. The straight side walls 51 are symmetrical about V-axis. The sectional shape of the yoke-mounting portion 5 takes the circular shape (FIG. 3A) only at the proximity of the rear end position Z1, and takes the substantially barrel shape (FIG. 3B) at an arbitrary position other than the proximity of the rear end position Z1.

The shapes of the outer surface 5a and the inner surface 5b of the yoke-mounting portion 5 will be described. The sectional shape of the outer surface 5a of the yoke-mounting portion 5, cut by the plane perpendicular to Z-axis, takes the circular shape (FIG. 3A) at the rear end position Z1. The sectional shape of the outer surface 5a varies from the circular shape to the substantially barrel shape (FIG. 3B), as the position shifts from the rear end position Z1 to the front end position Z2. In FIG. 3B, the outer surface 5a has two straight sides that straightly extend along V-axis, and two arc-shaped sides that extend in the form of circular arcs having the center of curvature aligned on Z-axis. Further, in FIG. 3B, the outer surface 5a has a maximum dimension at least in the direction of V-axis.

Similarly, the sectional shape of the inner surface 5b of the yoke-mounting portion 5, cut by the plane perpendicular to Z-axis, takes the circular shape (FIG. 3A) at the rear end position Z1. The sectional shape of the inner surface 5b varies from the circular shape to the substantially barrel shape (FIG. 3B), as the position shifts from the rear end position Z1 to the front end position Z2. In FIG. 3B, the inner surface 5b has two straight sides that straightly extend along V-axis, and two arc-shaped sides that extend in the form of circular arcs having the center of curvature aligned on Z-axis. Further, in FIG. 3B, the inner surface 5b has a maximum dimension at least in the direction of V-axis.

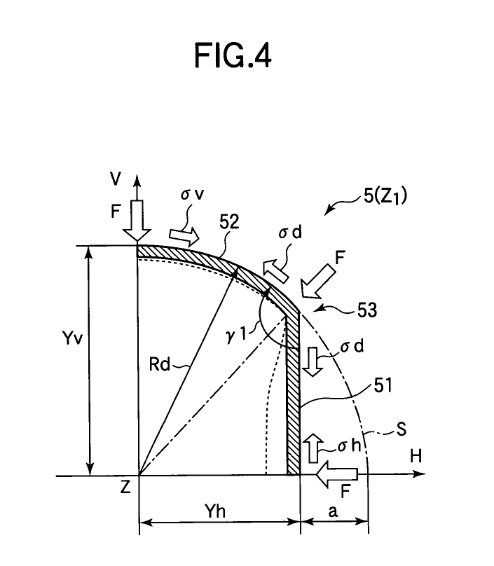

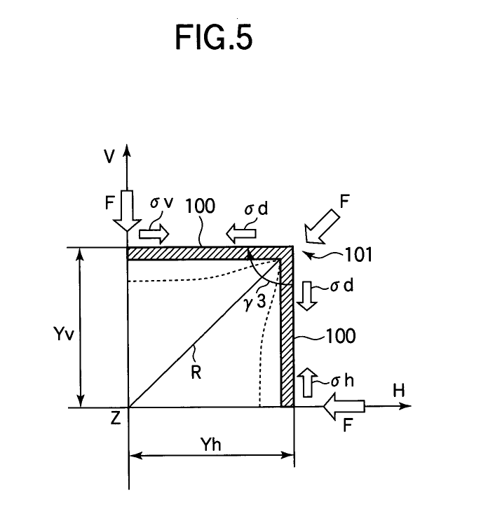

FIG. 4 shows one fourth of the sectional shape of the yoke-mounting portion 5 cut by a plane perpendicular to Z-axis at an arbitrary position other than the proximity of the rear end position Z1. FIG. 5 shows one fourth of the sectional shape of a conventional yoke-mounting portion. The sectional shape of the conventional yoke-mounting portion shown in FIG. 5 is rectangular, and therefore side walls 100 may deform inwardly by external pressure (i.e., atmospheric pressure) F when the vacuum enclosure is evacuated, so that compressive stresses h and v are generated on the outer surfaces of the side walls 100. When the side walls 100 deform inwardly, the angle γ3 of a corner 101 becomes acute, so that a large tension-stress d is applied to the outer surface of the corner 101, and therefore a crack may easily be generated at the corner 101.

In contrast, in the yoke-mounting portion 5 of Embodiment 1, the angle γ1 of the corner 53 is obtuse as shown in FIG.

4. Thus, even if the side walls 51 and 52 deform inwardly by the external pressure F as indicate by a dashed line when the vacuum enclosure is evacuated, the generation of a large tension-stress d on the outer surface of the corner 53 can be prevented. Further, the arc-shaped side wall 52 takes the form of the circular arc having the center of curvature aligned on Z-axis, and therefore the deformation of the arc-shaped side wall 52 caused by the external pressure F can be restricted to a small amount. As a result, it is possible to prevent the generation of the crack at the corner 53, so that the resistance to the external pressure can be improved.

As is also seen from FIG. 4, with the yoke-mounting portion 5, the distance from the deflection yoke 7 (FIG. 2) to the beam passage region in the funnel 2 can be reduced by an amount denoted by “a” along H-axis, compared with a yoke-mounting portion having a circular sectional shape shown by a dashed line S in FIG. 4. In particular, because of the straight side walls 51, the deflection yoke 7 (FIG. 2) can be located proximately to the beam passage region in the shape of a pincushion as indicated by “B” in FIG. 3B. As a result, the deflection magnetic field acts efficiently on the electron beam, and therefore the deflection power consumption can be reduced.

There is an additional effect of the Embodiment 1 regarding the provision of a getter and an inner conductive film. A getter material (not shown) is set in the funnel 2 and is evaporated by high-frequency heating during manufacture of the cathode ray tube. The getter is mounted on a getter supporting member 15 provided in the interior of the funnel 2 as shown in FIG. 2. The getter supporting member 15 is a strip-shaped member, and extends along the inner surface of the funnel 2. A getter vessel 15a for holding the getter material is provided at one end of the getter supporting member 15, and the other end of the getter supporting member 15 is fixed to the electron gun unit 31 in the neck 3. Even after the getter material is evaporated in the manufacturing process of the cathode ray tube, the getter supporting member 15 remains in the funnel 2.

According to Embodiment 1, the sectional shape of the inner surface 5b of the yoke-mounting portion 5 varies from the circular shape to the substantially barrel shape having the maximum dimension at least in the direction of V-axis, as the position shifts from the rear end position Z1 to the front end position Z2. Thus, there is a sufficient space for mounting the getter supporting member 15 on upper and lower sides of the beam passage region in the yoke-mounting portion 5. Therefore, the getter supporting member 15 can be mounted to a position sufficiently apart from the beam passage region, so that the shadow of the getter supporting member 15 does not appear on the screen 1a and the convergence is not degraded. As a result, it is not necessary to employ an alternative design of the cathode ray tube in which the getter supporting member 15 is mounted on an anode (not shown) or the like, and therefore it is not necessary to change the manufacturing process and to reform the manufacturing line on a large scale.

Moreover, the inner conductive film 16 is formed in the inner surface of the funnel 2. The inner conductive film 16 is made of a graphite or the like, and has a function to keep constant the electric potential of the interior of the vacuum enclosure 4. The inner conductive film 16 electrically connects a not-shown anode and a screen 1a, and connects the anode and an electrode of the electron gun 30. The inner conductive film 16 and an outer conductive film 17 formed on the outer surface of the funnel 2 constitute a capacitor that functions as a part of a driving circuit of a color television system. The inner conductive film 16 is formed by applying a graphite slurry to the inner surface of the funnel 2 while the funnel 2 is rotated, so that the graphite slurry flows from the front panel 1 side to the neck 3 side of the funnel 2. In the cathode ray tube according to Embodiment 1, the angle of the corner 53 (FIG. 3B) of the yoke-mounting portion 5 is obtuse, so that the accumulation of the graphite slurry at the corners 53 can be restricted. Thus, the coating of the graphite slurry becomes even. Therefore, after the slurry is dried, it is possible to prevent the inner conductive film 16 from flaking off, and to prevent the flakes from adhering to the shadow mask 11.

As described above, according to the cathode ray tube of Embodiment 1, each sectional shape of the outer and inner surfaces 5a and 5b of the yoke-mounting portion 5 (in the plane perpendicular to Z-axis) varies from the circular shape to the substantially barrel shape, as the position shifts from the rear end position Z1 to the front end position Z2, and therefore it is possible to improve the resistance to the external pressure, and to reduce the deflection power consumption. In addition, it is possible to prevent the electron beam from colliding with the inner surface of the yoke-mounting portion 5, so that the quality of the image can be improved. Further, it is possible to prevent the shadow of the getter supporting member 15 from appearing on the screen 1a, and to simplify the formation of the inner conductive film 16.

Particularly, where the yoke-mounting portion 5 takes the substantially barrel shape, the yoke-mounting portion 5 includes two straight side walls 51 and two arc-shaped side walls 52 having the center aligned on the Z-axis, and has the maximum dimension at least in the direction of V-axis. Thus, the deformation caused by the external pressure F can be restricted to a minimum value, and therefore the generation of the crack can be efficiently prevented. Further, the deflection yoke 7 can be placed in the vicinity of the beam passage region, with the result that the deflection power consumption can be reduced.

In the above described construction, each of the outer surface 5a and the inner surface 5b varies from the circular shape to the substantially barrel shape. However, it is possible that only the outer surface 5a of the yoke-mounting portion 5 varies from the circular shape to the substantially barrel shape, as the position shifts from the rear end position Z1 to the front end position Z2. With such an arrangement, the angle of the corner 53 is obtuse, and it is still possible to have the advantage of the improved external pressure.

Embodiment 2.

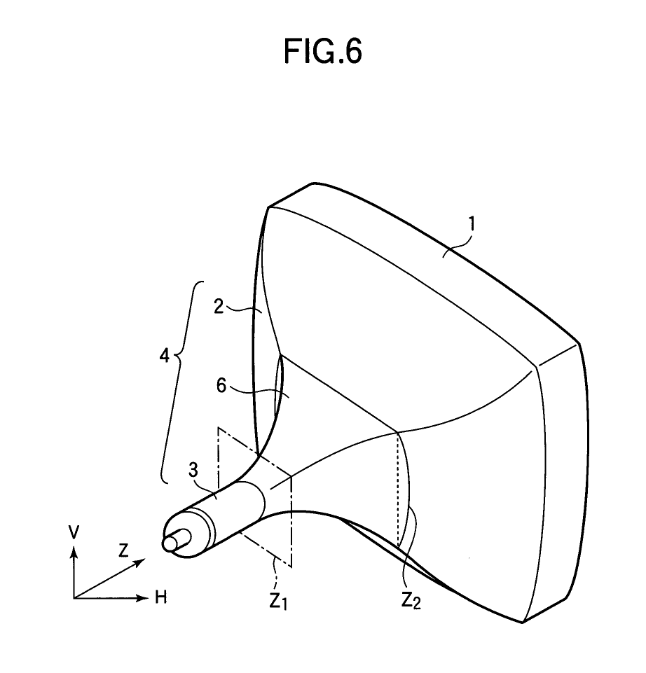

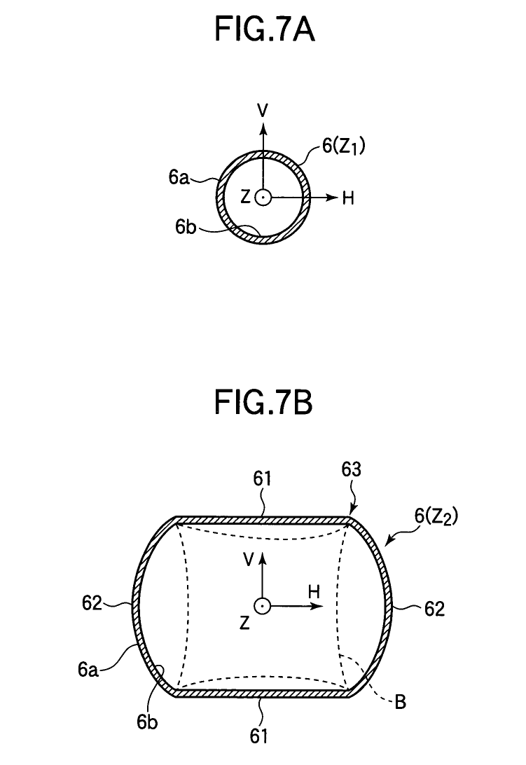

FIG. 6 is a perspective view of a cathode ray tube according to Embodiment 2. FIGS. 7A and 7B are schematic views illustrating the sectional shapes of the yoke-mounting portion 6, cut by the plane perpendicular to Z-axis, at the rear end position Z1 and the front end position Z2.

The sectional shape of the yoke-mounting portion 6, cut by the plane perpendicular to Z-axis, is the circular shape at the rear end position Z1 as shown in FIG. 7A. The sectional shape of the yoke-mounting portion 6 gradually varies from the circular shape to the substantially barrel shape (FIG. 7B), as the position shifts from the rear end position Z1 to the front end position Z2. In FIG. 7B, the yoke-mounting portion 6 includes two straight side walls 61 and two arc-shaped side walls 62. The straight side walls 61 straightly extend along H-axis. The arc-shaped side walls 62 extend in the form of circular arcs having a radius Rd and having the center of curvature aligned on Z-axis. Corners 63 between the straight side walls 61 and the arc-shaped side walls 62 are obtuse-angled. The arc-shaped side walls 62 are symmetrical about V-axis, and bend outward in the direction away from Z-axis. The straight side walls 61 are symmetrical about H-axis.

The shapes of the outer surface 6a and the inner surface 6b of the yoke-mounting portion 6 will be described. The sectional shape of the outer surface 6a of the yoke-mounting portion 6, cut by the plane perpendicular to Z-axis, takes the circular shape (FIG. 7A) at the rear end position Z1. The sectional shape of the outer surface 6a varies from the circular shape to the substantially barrel shape (FIG. 7B), as the position shifts from the rear end position Z1 to the front end position Z2. In FIG. 7B, the outer surface 6a has two straight sides that straightly extend along H-axis, and two arc-shaped sides that extend in the form of circular arcs having the center of curvature aligned on Z-axis. Further, in FIG. 7B, the outer surface 6a has a maximum dimension at least in the direction of H-axis.

Similarly, the sectional shape of the inner surface 6b of the yoke-mounting portion 6, cut by the plane perpendicular to Z-axis, takes the circular shape (FIG. 7A) at the rear end position Z1. The sectional shape of the inner surface 6b varies from the circular shape to the substantially barrel shape (FIG. 7B), as the position shifts from the rear end position Z1 to the front end position Z2. In FIG. 7B, the inner surface 6b has two straight sides that straightly extend along H-axis, and two arc-shaped sides that extend in the form of circular arcs having the center of curvature aligned on Z-axis. Further, in FIG. 7B, the inter surface 6b has a maximum dimension at least in the direction of H-axis.

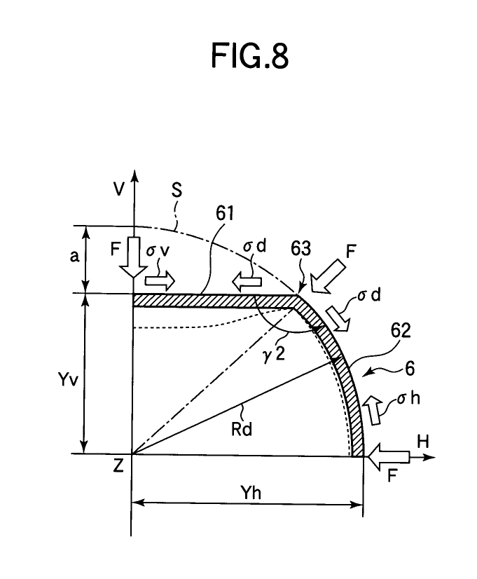

FIG. 8 shows one fourth of the sectional shape of the yoke-mounting portion 6, cut by a plane perpendicular to Z-axis at an arbitrary position other than the proximity of the rear end position Z1. In the yoke-mounting portion 6 of Embodiment 2, the angle γ2 of the corner 63 is obtuse as shown in FIG. 8. Thus, even if the side walls 61 and 62 deform inwardly by the external pressure F as indicate by a dashed line when the vacuum enclosure is evacuated, the generation of a large tension-stress d on the outer surface of the corner 63 can be prevented. Further, the side wall 62 is in the form of the circular arc having the center aligned on Z-axis, and therefore the deformation of the side wall 62 caused by the external pressure F can be restricted to a small amount. As a result, it is possible to restrict the generation of the crack on the corner 63, so that the resistance to the external pressure can be improved.

Further, as shown in FIG. 8, with the yoke-mounting portion 6, the distance from the deflection yoke 7 (FIG. 2) to the beam passage region can be reduced by an amount denoted by “a” along V-axis, compared with a yoke-mounting portion having a circular sectional shape shown by a dashed line S in FIG. 8. In particular, because of the straight side walls 61, the deflection yoke 7 (FIG. 2) can be located proximately to the beam passage region in the shape of a pincushion as indicated by “B” in FIG. 7B. As a result, the deflection magnetic field acts efficiently on the electron beam, and therefore the deflection power consumption can be reduced.

Moreover, there is a sufficient space for providing the getter supporting member 15 (FIG. 2) on the left and right sides of the beam passage region inside the yoke-mounting portion 6. Thus, the getter supporting member 15 can be mounted to a position sufficiently apart from the beam passage region so that the shadow of the getter supporting member 15 does not appear on the screen 1a and that the convergence is not degraded. Furthermore, the accumulation of the graphite slurry at the corners 63 can be restricted, and therefore the coating becomes even. Thus, it is possible to prevent the inner conductive film 16 from flaking off.

As was described in Embodiment 1, it is possible that only the outer surface 6a of the yoke-mounting portion 6 varies from the circular shape to the substantially barrel shape, as the position shifts from the rear end position Z1 to the front end position Z2. With such an arrangement, the angle of the corner 63 (FIG. 7B) is obtuse, and therefore it is still possible to have the advantage of the improved resistance to the external pressure.

Next, the numerical analysis for improving the deflection sensitivity and for preventing a so-called BSN phenomenon will be described. The BSN phenomenon is a phenomenon where the electron beam collides with the inner surface of the yoke-mounting portion. The structures of the yoke-mounting portions 5 and 6 are the same as those described in Embodiments 1 and 2 with reference to FIGS. 4 and 8.

With regard to the outer surface 5a of the yoke-mounting portion 5 (FIG. 4), distances Yh and Yv are defined in a plane perpendicular to Z-axis at an arbitrary position other than the proximity of the rear end position Z1. The distance Yh represents the distance from Z-axis to the outer surface 5a of the yoke-mounting portion 5 in the direction of H-axis. The distance Yv represents the distance from Z-axis to the outer surface 5a of the yoke-mounting portion 5 in the direction of V-axis. Further, as described above, the aspect ratio of the screen 1a (i.e., the ratio of the dimension along H-axis to the dimension along V-axis) is expressed as M:N. The optimum relationship between these distances Yh and Yv and the aspect ratio M:N regarding the outer surface 5a is determined by a deflection-magnetic-field simulation analysis in which the trajectory of the electron beam emitted by the electron gun 30 and the magnetic field generated by the deflection yoke 7 are analyzed. With regard to the inner surface 5b of the yoke-mounting portion 5, the optimum relationship is determined in a similar manner.

With regard to the outer surface 6a of the yoke-mounting portion 6 (FIG. 8), distances Yh and Yv are defined in a plane perpendicular to Z-axis at an arbitrary position other than the proximity of the rear end position Z1. The distance Yh represents the distance from Z-axis to the outer surface 6a of the yoke-mounting portion 6 in the direction of H-axis. The distance Yv represents the distance from Z-axis to the outer surface 6a of the yoke-mounting portion 6 in the direction of V-axis. Further, the aspect ratio of the screen 1a is expressed as M:N. The optimum relationship between these distances Yh and Yv and the aspect ratio M:N regarding the outer surface 6a is determined by the above described simulation analysis. With regard to the inner surface 6b of the yoke-mounting portion 6, the optimum relationship is determined in a similar manner.

As a result of the analysis, the optimum relationship (1) is obtained for improving the deflection sensitivity and preventing the BSN phenomenon in the cathode ray tube according to Embodiment 1 (where Yh<Yv). Further, the optimum relationship (2) is obtained for improving the deflection sensitivity and preventing the BSN phenomenon in the cathode ray tube according to Embodiment 2 (where Yh>Yv).
0.6×(N/M)(Yv²−Yh²)^{1/2}/Yh1.2×(N/M) (1)
1.2×(N/M)Yv/(Yh²−Yv²)^{1/2}1.8×(N/M) (2)

In determining the relationships (1) and (2), it is possible to use the data of the radius Rd of the conventional yoke-mounting portion having substantially cone-shaped sectional shape. The distance Yv can be set to Rd (Yv=Rd) when the distance Yh is smaller than the distance Yv (i.e., the relationship (1)), and the distance Yh can be set to Rd (Yv=Rd) when the distance Yh is greater than the distance Yv (i.e., the relationship (2)), so that the analysis can be easily performed. The radius Rd is different from a diagonal dimension R (FIG. 5) of the yoke-mounting portion 5 having a rectangular sectional shape.

The initial condition of the above described analysis will be described. The horizontal deflection magnetic field is in the shape of a pincushion, and the vertical deflection magnetic field is in the shape of a barrel. Further, the center of the vertical deflection magnetic field is positioned closer to the neck 3 than the center of the horizontal deflection magnetic field is. Thus, the electron beam directed to the corner of the screen 1a is initially deflected strongly in the direction of V-axis, and then deflected gradually in the directions of H-axis and V-axis. Therefore, the aspect ratio of the beam passage region in the funnel 2 is different from the aspect ratio of the screen 1a. Thus, the following relationship (3) is used as the initial condition of the analysis when the distance Yh is smaller than the distance Yv. Similarly, the following relationship (4) is used as the initial condition of the analysis when the distance Yh is greater than the distance Yv.
N/M=≠(Yv²−Yh)^{1/2}/Yh (3)
N/MYv/(Yh²−Yv²)^{1/2} (4)

As described above, when the outer surface 5a and the inner surface 5b of the yoke-mounting portion 5 satisfy the relationship (1), and when the outer surface 6a and the inner surface 6b of the yoke-mounting portion 6 satisfy the relationship (2), the deflection sensitivity can be improved and therefore the deflection power consumption can be reduced. In addition, the collision of the electron beam with the inner surface of the yoke-mounting portions 5 and 6 can be prevented, and therefore the degradation of the image can be prevented.

While the preferred embodiments of the present invention have been illustrated in detail, it should be apparent that modifications and improvements may be made to the invention without departing from the spirit and scope of the invention as described in the following claims.

1. A cathode ray tube comprising:
a vacuum enclosure including a panel having a substantially rectangular screen on which a horizontal direction and a vertical direction are defined;
a substantially funnel-shaped portion in which a tube axis is defined, one end of said funnel-shaped portion in a direction of said tube axis being connected to said panel, a substantially cylindrical neck connected to an opposite end of said funnel-shaped portion; and
an electron gun mounted in said neck;
wherein said funnel-shaped portion includes a yoke-mounting portion adjacent to said neck, said yoke-mounting portion having an outer surface for mounting a deflection yoke that deflects an electron beam emitted by said electron gun in directions of said horizontal axis and said vertical axis, and
wherein a sectional shape of said outer surface of said yoke-mounting portion, cut by a plane perpendicular to said tube axis, varies from a substantially circular shape to a substantially barrel shape having a maximum dimension at least in a direction of said horizontal axis or said vertical axis, as the position shifts from said neck side to said panel side of said yoke-mounting portion.

2. The cathode ray tube according to claim 1, wherein a sectional shape of an inner surface of said yoke-mounting portion, cut by a plane perpendicular to said tube axis, varies from a substantially circular shape to a substantially barrel shape having a maximum dimension in the same direction as the direction in which said outer surface has its maximum dimension.

3. The cathode ray tube according to claim 1, wherein said substantially barrel shape includes two substantially straight sides extending in parallel with each other along said horizontal axis or said vertical axis, and two arc-shaped sides in the form of circular arcs having the center of curvature aligned on said tube axis.

4. The cathode ray tube according to claim 2, wherein each of said outer surface and said inner surface has a sectional shape having maximum dimensions Yh and Yv respectively along said horizontal axis and said vertical axis, in a plane perpendicular to said tube axis at an arbitrary position other than the proximity of said neck, and
wherein said maximum dimensions Yh and Yv satisfying the following relationships (1) and (2):
0.6×(N/M)(Yv²−Yh²)^{1/2}/Yh1.2×(N/M) (1)
when Yh is smaller than Yv
1.2×(N/M)Yv/(Yh²−Yv²)^{1/2}1.8×(N/M) (2)
when Yh is greater than Yv
where M and N respectively represent dimensions of said screen along said horizontal axis and said vertical axis.
